(19) United States
(12) Patent Application Publication
(10) Pub. No.: US 2006/0134273 A1
(43) Pub. Date: Jun. 22, 2006

(54) Method and apparatus for making a sandwich

(76) Inventors: Kathryn V. Proper, Chicago, IL (US); Henry T. Ewald, Roselle, IL (US); Paul G. Simmons, Glen Ellyn, IL (US)

Correspondence Address: RYNDAK & SURI LLP, 200 W MADISON STREET, SUITE 2100, CHICAGO, IL, 60602, US

(21) Appl. No.: 11/018,989

(22) Filed: Dec. 21, 2004

(51) Int. Cl. A21D 13/00

(52) U.S. Cl. 426/94

(57) ABSTRACT

The present invention relates to a sandwich assembly tool and methods of making a sandwich, which may be a hot or cold sandwich, quickly by pre-assembly of various sandwich components and simultaneous preparation of different parts of the same sandwich. The sandwich assembly tool is composed of a member preferably having one or two cavities for containing a quantity of garnish. The cavities are used for the assembly of the sandwich. The tool may have a raised ridge adjacent one or both cavities for placement against the hinge of a bread component. Methods of making a sandwich are disclosed. The methods may include one or more of the use of preassembled sandwich fillings, assembly of garnishes in advance of a customer's order or while other portions of the sandwich are being heated using the sandwich assembly tool, the simultaneous heating of a bread component and the sandwich filling, placing the bread component over the tool containing garnish, and inverting the tool and bread combination to deposit the sandwich garnish onto the bread component.

### TECHNICAL FIELD

The present invention relates to methods of making a sandwich. In one aspect, the invention relates to pre-assembly of sandwich components and simultaneous preparation of different parts of the same sandwich. In one aspect, the invention relates to one or more of the following: pre-assembly of meat and cheese; simultaneous toasting of a bread component and heating a pre-assembled meat and/or cheese filling; and assembly of sandwich garnishes and condiments on a sandwich assembly tool. In another aspect, the present invention relates to a sandwich assembly tool useful in the foregoing methods for preparation of a sandwich, including, for example, a made-to-order sandwich.

### BACKGROUND OF THE INVENTION

Hot sandwiches that are made to order and served quickly are desirable. Sandwiches with a toasted roll or bun, heated meat and/or cheese filling and cold garnish would be especially desirable if such sandwiches could be made and served quickly. One reason is that the toasting and heating creates preferred textures such as toasted bread and melted cheese. The heating also releases flavors in a way that does not occur in a cold sandwich. Finally, it would be desirable to provide to customers such a made-to-order sandwich, including a hot sandwich, neatly, efficiently and consistently prepared with the convenience and speed of quick service food.

It is advantageous for sandwiches to be served when freshly made. Otherwise, when consumed, the sandwich may not have the sensory appeal of being “fresh” For example, depending on the type of sandwich, portions may become undesirably cool, the sandwich garnish and condiments too warm, or the bread soggy after absorbing moisture from the sandwich filling and/or garnish and condiments. Thus, a need exists to quickly make sandwiches, on order demand, to maintain desired sandwich component temperatures and textures. In addition, a need exists to assemble different parts of the sandwich simultaneously or essentially simultaneously to make and serve sandwiches quickly especially if significant cooking or heating times are necessary for the bread or for the filling.

However, the demand for such sandwiches peaks at lunch and dinner times and the demand can be relatively slow between these peak periods causing labor scheduling problems or causing the restaurant to be overstaffed or understaffed during the day. Consequently, a need exists to minimize the labor required during peak periods. A consistent sandwich preparation system, method and device is needed that maximizes achieving desirable sensory perceptions when sandwich garnishes and condiments such as, for example, lettuce, mayonnaise and tomato are cool, but other portions of the sandwich are hot, such as bread and/or meat and cheese.

It is also advantageous to provide consistent sandwich quality and appearance, especially when they are purchased from a quick service restaurant. This consistency is important to achieve regardless of the person that makes the sandwich.

### SUMMARY OF THE INVENTION

In accordance with the present invention, novel methods of making a sandwich and novel sandwich assembly tools are provided. While the invention is suited for making practically any type of sandwich, the invention is particularly suited for making sandwiches in a commercial environment.

As used herein, the terms “bread component” and “bread” are intended to have a very broad meaning and can be leavened or unleavened. “Bread component” and “bread” is intended to have a very broad meaning and includes, but is not limited to, for example, rolls, buns, sliced bread, croissants, bagels, pita bread, taco shells, and tortillas. Typically, a sandwich that has a bread component for its exterior or a portion thereof includes, but is not limited to, for example, a submarine or “sub” or “hero” sandwich, a hamburger or cheeseburger sandwich, a reuben sandwich, a hot dog sandwich, a wrap sandwich, and a burrito sandwich and can be eaten by hand and without any utensils. “Bread component” can refer to a bread product having several separate pieces like a hamburger bun or to one of those separate pieces. The terms “sandwich garnish material,” “sandwich garnish” or “garnish” are intended to have a very broad meaning and may be any suitable garnish for a sandwich. Thus, “sandwich garnish material,” “sandwich garnish” and “garnish” include, but are not limited to, for example, lettuce, onions, tomatoes, pickles, chili, coleslaw, giardinera, peppers, spinach, radishes, olives, egg, cooked bacon, and cheese. For purposes of this patent, a garnish which contains a mixture of garnish materials can be considered to be a single garnish material and may be pre-mixed. Examples include coleslaw, chili, and giardinera.

“Sandwich condiment” is intended to have a very broad meaning and includes any material used as a sandwich condiment. The “sandwich condiment” or “condiment” includes, but is not limited to, for example, ketchup, mustard, mayonnaise, sauces, relish, oils, salt, pepper, barbecue sauce, steak sauce, hot sauce, dressings including salad dressings, yogurt, butter, margarine, and liquid or semi-liquid cheese. The sandwich fillings include, but are not limited to, cold cuts, steak, hamburger patties, chicken patties, sausage, hot dogs, meatballs in sauce, cured meats, pork, veal, turkey, cheese, eggs, fish, grilled vegetables, and vegetarian fillings not limited to imitations of meat, dairy or fish products. Often the sandwich filling is the source of the name of the sandwich, for example, ham sandwich, Italian sausage sandwich, beef burrito. Often the sandwich filling is the main source of protein in the sandwich.

In accordance with one aspect of the invention, a sandwich assembly tool is provided. The tool can be used for the production of sandwiches, whether any or all components are heated, chilled or at ambient temperature, as desired. In one embodiment, the assembly tool is composed of a member for holding sandwich garnish material to be applied to a bread component, the member comprising at least one cavity. In one embodiment, the assembly tool may include one, two or more cavities, depending on the type of sandwich to be made. The at least one cavity is configured to contain sandwich garnish material therein and has a desired volume to contain a desired quantity of garnish placed therein. The garnish contained by the tool is considered in contact with the tool regardless of whether it is in direct physical contact with the tool or whether a liner, including a replaceable or discardable liner is between the garnish and the surface of the tool. If the assembly tool has two cavities, one cavity may be a heel cavity and the other cavity may be a crown cavity, corresponding to the heel and crown halves of a bread component. The cavities preferably generally correspond to the cross-sectional area and shape of the bread that is to be used with the sandwich assembly tool. When an assembly tool containing sandwich garnish material is inverted over or onto an open sandwich roll or other bread component, the sandwich garnish in the heel and/or crown cavities (if present) falls or is otherwise deposited onto the heel and crown of the roll without spilling over. In one embodiment, the capacity of the cavity or of each of the cavities of the sandwich assembly tool is in the range of from about 100 to about 375 cubic centimeters.

In one embodiment, the sandwich assembly tool has a raised ridge between the two cavities. The ridge preferably has a suitable length, width, and height so that the ridge restricts sandwich garnish from entering the hinge area (the region of the roll or bun that connects the head to the crown) of a roll or a bun when the sandwich assembly tool is inverted and the contents are deposited on the roll or bun. This facilitates the construction of a neat, uniform sandwich and helps to prevent the sandwich roll or bun from breaking apart in the hinge area when the sandwich is closed. Also, the sandwich has a greater tendency to remain closed obviating the need to tightly wrap the sandwich to hold it together thereby also reducing compression of the sandwich materials. Thus, the ridge can facilitate sandwich preparation and reduce sandwich preparation time while increasing consumer convenience because the consumer does not have to remove a tightly wrapped wrapper to eat the sandwich. In addition, the ridge provides a neater and uniform presentation of the completed sandwich because sandwich garnish material and condiments are not in the hinge region and thus do not tend to migrate from one bread half to the other.

In accordance with one aspect of the invention, a sandwich assembly tool for making a sandwich composed of at least a bread component and sandwich garnish is provided comprising a member with two separate spaced apart cavities for holding sandwich garnish material to be applied to a bread component for a sandwich, each cavity having an opening located in substantially the same plane; and a quantity of sandwich garnish material contained in and in contact with at least one of the cavities. The cavities are of substantially equal size and volume. The tool may further comprise a peripheral planar area located adjacent and in substantially the same plane as the cavity openings and the planar area forming a peripheral region of the member and that is configured to permit a bread component to cover the cavities and overlap the planar area. The peripheral planar area has a width in the range of about 0.25 to about 2 inches and the planar area adjacent one cavity has the indicia “heel” and the planar area adjacent the other cavity has the indicia “crown.” The sandwich assembly tool has a ridge extending upwardly between the openings of the two cavities. The ridge has a width in the range of from about 5 millimeters to about 17 millimeters and a height in the range of from about 2 millimeters to about 20 millimeters.

In accordance with another aspect of the invention, a method of making a sandwich composed of at least a bread component and sandwich garnish is provided, comprising placing sandwich garnish material on a sandwich assembly tool. The sandwich assembly tool has a region for holding sandwich garnish material to be applied to a bread component of a sandwich and the tool comprises at least one cavity. Sandwich garnish is placed in the cavity, a bread component is placed over and adjacent the cavity and thereafter the sandwich assembly tool is inverted while the bread is adjacent and covering the cavity to cause the sandwich garnish to be deposited from the cavity to the bread component. In a sandwich assembly tool having two cavities, sandwich garnish is placed in both cavities, and the sandwich assembly tool is inverted while a bread component completely covers both cavities to cause the garnish in the cavities to be deposited on the bread component.

In accordance with another aspect of the invention, a sandwich assembly tool is provided, comprising a member having a single cavity for holding sandwich garnish material, the cavity having an opening located in substantially a single plane; and a peripheral planar area adjacent and surrounding the opening and in substantially the same plane as the opening. The peripheral planar area adjacent one region of the cavity is longer and wider than the cavity opening and has a width in the range of from about 0.25 to about 2.0 inches.

The sandwich assembly tool and method of making a sandwich allows sandwiches to be assembled quickly, and uniformly, thereby reducing the amount of time and labor needed to make a sandwich. Also, garnishes, sandwich fillings, and condiments can be assembled in advance of an order for a sandwich as desired. Sandwiches can be made more quickly by allowing multiple tasks in the preparation of a sandwich to occur simultaneously or substantially simultaneously rather than sequentially. In particular, the sandwich garnish, condiments, and/or sandwich fillings can be assembled during a slow period of the day in advance of busy sandwich order periods such as lunch and dinner and stored in a desired environment, such as a heated or refrigerated environment. This gives restaurants much more flexibility in scheduling employees and makes restaurants more efficient. When sandwich garnishes and/or fillings are assembled in advance, preferably the assembled sandwich garnish and/or filling is stored in the tool in an environment maintained at a temperature safe for foods. Typically, the environment is chilled or heated. Typical temperatures for chilled and heated environments are 33 to 40° F. and 140 to 210° F., respectively.

In one embodiment of the method in accordance with the invention, a sandwich assembly tool with at least one cavity is utilized. Sandwich garnish and/or condiment is put on the tool, the bread component placed over the cavity and thereafter the tool and the bread component is inverted over the bread component of a sandwich thereby depositing the sandwich garnish and/or condiment to the bread component. The bread component can be as desired and thus can be heated or unheated. Typically, a sandwich filling will thereafter be placed in the bread component of any desired type and temperature.

In another embodiment, the method uses an assembly tool having two separate cavities. In this method, sandwich garnishes are put into one or both of the two cavities of the assembly tool and optionally a condiment is applied in one or both of the two cavities. Next the tool is inverted onto or over the bread component of the sandwich so that sandwich garnish from each cavity is deposited onto two different portions or halves of the bread component. The bread component may be placed over and adjacent the cavities with the bread component being inverted with the assembly tool while maintaining the bread component adjacent the assembly tool to cause the garnish and/or condiment to be deposited onto the bread component.

In another embodiment of the invention, a sandwich filling is heated and/or a bread component is optionally heated separately from the sandwich filling. A condiment and/or a sandwich garnish may be placed on the tool prior to or while (or even after) the filling and/or the bread component is heated. Thereafter, the bread component, whether heated or not, is placed on top of the condiment and sandwich garnish combination. “Heating” is intended to have a very broad meaning and includes any method for cooking or increasing the temperature of a food. Thus, “heating” includes, but is not limited to, for example, grilling, broiling, steaming, microwaving, flash steaming, toasting, frying, conduction, convection, sautéing, boiling, poaching and searing.

Sandwich preparation in accordance with the invention can include placing sandwich garnish and/or condiment directly on a piece of paper, a wrapper that is eventually used to contain the sandwich, the container used to hold the completed sandwich when it is presented to the consumer, or preferably a tool adapted for assembling and applying garnishes.

In another aspect of the invention, after an order for a sandwich is taken from a customer, a bread component is heated for less than about one minute in response to the order in a first heating device, and/or a sandwich filling is heated in a second device. Preferably, the sandwich filling is heated from 40° F. or less to 150° F. or more while the bread component is being heated, typically rapidly toasted in less than thirty (30) seconds, in response to the order.

In another embodiment, an order for a sandwich is taken from a customer and a preassembled sandwich filling is heated from 40° F. or less to 150° F. or more within twenty seconds in response to the order. The preassembled sandwich filling may be a single or multiple food component and may have at least one slice or amount of a first foodstuff, which may be sliced, diced, shredded, grated, chopped, liquid and a quantity of a second foodstuff. For purposes of the patent, a foodstuff which contains a mixture of components is considered to be a single foodstuff when the garnishes are usually pre-mixed rather than being separate components which are added separately to a sandwich. Examples of this include chili; sausage, which may be made from several different animals, beer or wine, cheese, and spices; vegetable patties, which may be made from several different grains, small chunks of vegetables, and small chunks of cheese; and coated or breaded patties, which typically has a meat or meat-substitute and a bread coating. In a preferred embodiment, the preassembled sandwich filling includes a separator, typically in the form of a sheet or film, which makes the filling easier to handle. The separator may be a good conductor of heat, and can be a foil, parchment paper or polymer sheet or film material, for example.

In another aspect of the invention, a sandwich filling and a bread component are heated. Prior to or while the filling and bread component are heating, a first sandwich garnish is combined with a second sandwich garnish. Next the heated bread component is placed on top of the sandwich garnish combination. In a preferred aspect, a hamburger is assembled using a clamshell container, which can be used to package the completed hamburger.

In another embodiment, an order for a sandwich is taken from a customer and a bread component is placed onto a pre-heated, preassembled sandwich filling. The filling is made from two or more foodstuffs. Next the bread component and filling combination are inverted.

### BRIEF DESCRIPTION OF THE DRAWINGS

FIG. 1 is a perspective view of a sandwich assembly tool in accordance with the invention;

FIG. 2 is a cross-sectional view of the sandwich assembly tool taken along lines 2-2 of FIG. 1;

FIG. 3 is a side elevation view of the sandwich assembly tool of FIG. 1;

FIGS. 4-5 are perspective views of garnishes placed in the sandwich assembly tool of FIG. 1 in accordance with the method of the present invention;

FIGS. 6-7 are cross-sectional views of condiment and garnish contained in the sandwich assembly tool of FIG. 1;

FIG. 8 is a perspective view of a bread component placed onto the tool of FIG. 7, ready for inversion;

FIGS. 9-10 are cross-sectional views of the tool of FIGS. 1-8 inverted on a bread roll with garnish and condiment therein and being deposited onto the bread component;

FIG. 11 is a cross-sectional view of the bread component, garnish and condiments from FIG. 10 after the tool has been removed;

FIG. 12 is a cross-sectional view of the sandwich after the filling has been applied over the garnish and condiments in accordance with the method of the present invention;

FIG. 12A is a cross-sectional view of the sandwich of FIG. 12 after the filling has been wedged against the roll hinge;

FIG. 13 is a cross-sectional view of the sandwich of FIG. 12 in an open position after the separator sheet has been removed;

FIG. 14 is a perspective view of the completed, closed sandwich;

FIGS. 15-17 are cross-sectional views of the sandwich of FIG. 14 being wrapped in a wrapper;

FIG. 18 is a perspective view of another embodiment of a sandwich assembly tool in accordance with the invention;

FIG. 19 is a cross-sectional view of the sandwich assembly tool of FIG. 18 taken along lines 19-19 of FIG. 18;

FIG. 20 is a perspective view of still another embodiment of a sandwich assembly tool in accordance with the invention;

FIG. 21 is a cross-sectional view along lines 21-21 of FIG. 20;

FIG. 22 is a perspective view of another embodiment of a sandwich assembly tool in accordance with the invention;

FIG. 23 is a cross-sectional view along lines 15-15 of FIG. 22;

FIG. 24 is a perspective view of yet another embodiment of a sandwich assembly tool in accordance with the invention;

FIG. 25 is a cross-sectional view along lines 25-25 of FIG. 24;

FIG. 26 is a perspective view of another embodiment of a sandwich assembly tool in accordance with the invention;

FIG. 27 is a cross-sectional view along lines 27-27 of FIG. 26;

FIG. 28 is a perspective view of yet another embodiment of a sandwich assembly tool in accordance with the invention;

FIG. 29 is a cross-sectional view along lines 29-29 of FIG. 28;

FIG. 30 is a perspective view of still another embodiment of a sandwich assembly tool in accordance with the invention;

FIG. 31 is a cross-sectional view along lines 31-31 of FIG. 30;

FIGS. 32-40 illustrate a method in accordance with the invention in which a hamburger sandwich having cheese and a middle bread component layer is assembled using the tool of FIG. 31;

FIGS. 41-49 illustrate a method in accordance with the invention in which a hamburger sandwich having cheese is assembled;

FIG. 50 illustrates the sandwich assembly tool of FIG. 1 containing sandwich filling and garnishes;

FIGS. 51-52 illustrate another embodiment of a sandwich assembly tool in accordance with the invention;

FIG. 53 illustrates the making of a sliced bread sandwich; and

FIGS. 54-59 are flow charts for making different types of sandwiches.

### DETAILED DESCRIPTION OF THE INVENTION

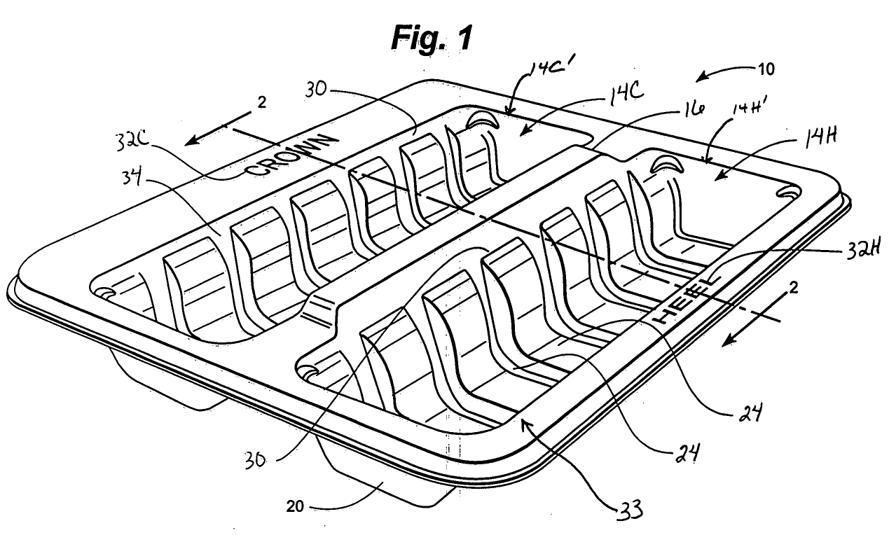

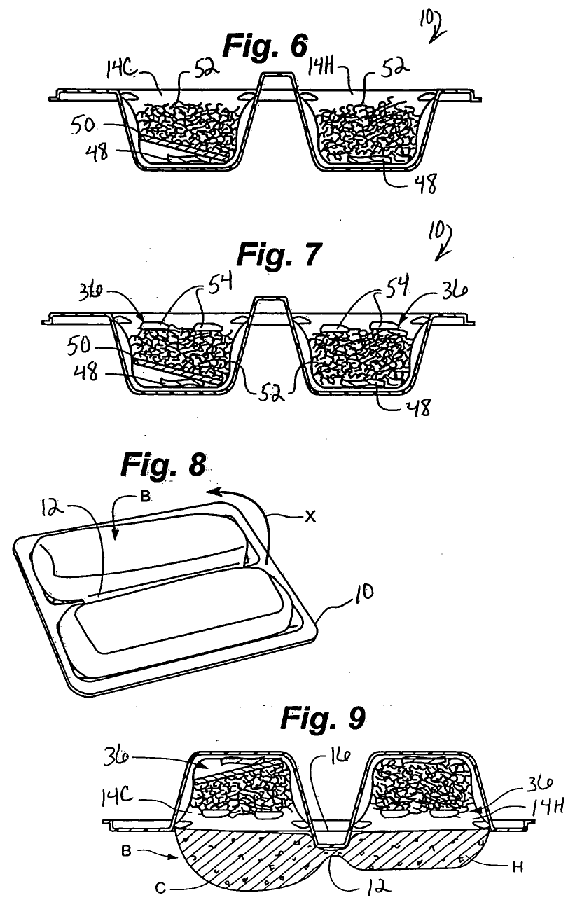

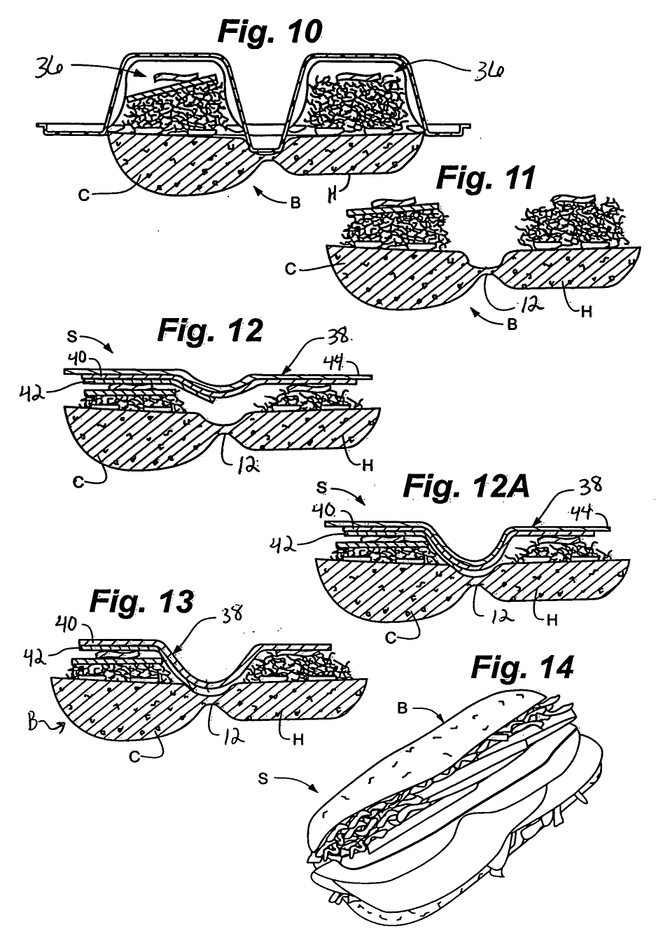

Referring to the Figures generally, and in particular to FIGS. 1-14, where like reference numerals denote like elements, there is illustrated a sandwich assembly tool 10 and a method of making a sandwich in accordance with the invention.

Sandwich Assembly Tool Adapted for “Sub” Rolls

A preferred sandwich assembly tool 10 for making a sandwich is depicted. In the illustrated embodiment of FIGS. 1-14, a sandwich S is made with a bread component B that has a crown or top portion C and a heel or bottom portion H connected to each other by a hinge portion 12. Preferred sandwich assembly tool 10 has two cavities 14C, 14H and a raised ridge 16 between cavities 14C, 14H. Each cavity 14C, 14H has opposing sidewalls 18, end walls 20, and bottom wall 22. Cavities 14C, 14H can be used for the assembly of sandwich garnishes.

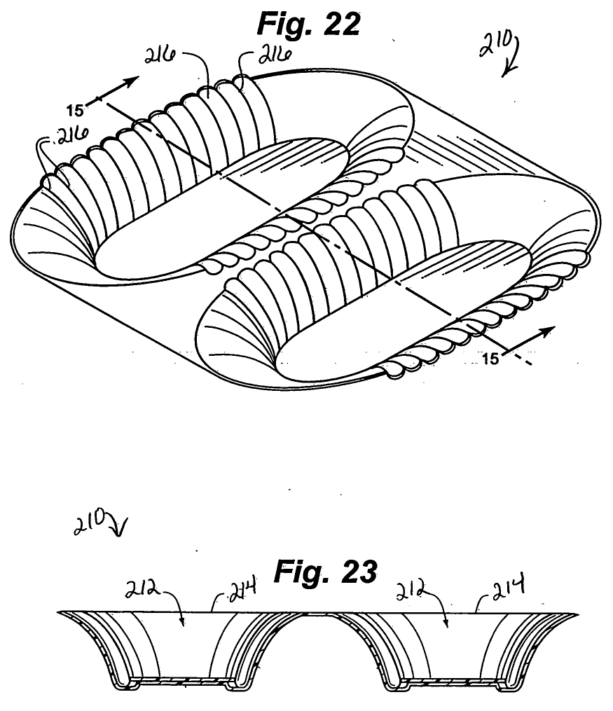

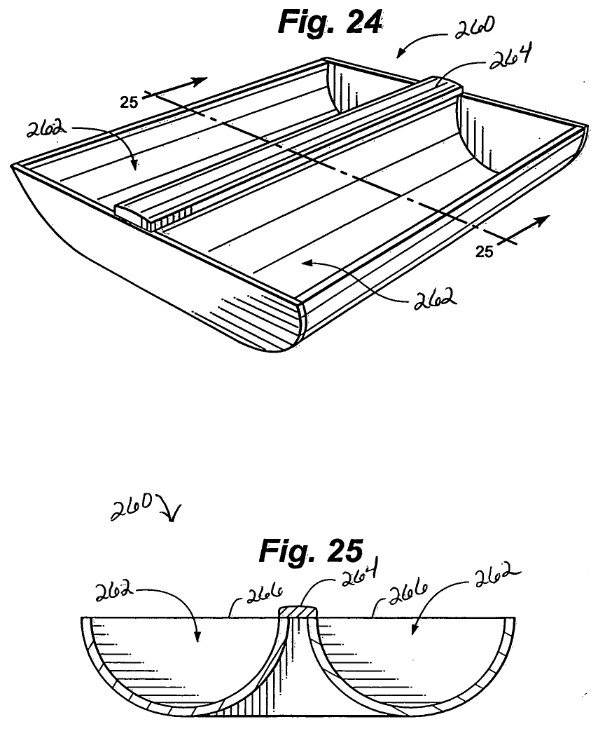

FIGS. 1-3, 18-19, and 51-52, which are hereinafter discussed in greater detail, illustrate various sandwich assembly tools in accordance with the invention that have protrusions for facilitating discharge of the garnish and/or condiments on their sidewalls. FIGS. 24-29 illustrate cavities that do not have protrusions. FIGS. 22-23 illustrate a sandwich assembly tool that has protrusions on its sidewalls only. Some protrusions protrude inwardly into the cavity and some protrusions protrude outwardly from the cavity. The protrusions can be any desired shape and size.

As illustrated in FIG. 1, protrusions 24 protrude downwards from the bottom of tool 10 and can engage hollows 26 of a support 28 as illustrated in FIG. 3. When the protrusions 24 engage hollows 26, tool 10 tends to stay in the same position as garnishes and condiments are placed in cavities 14C, 14H. In FIG. 3, support 28 is a wire rack and hollows 26 are the spaces between the wires of rack 28.

Support 28 can be a support such as a tabletop or a top for a food preparation workstation (not shown). Additionally, support 28 can be located in a heated or chilled area, or in a heating device. Hollows 26 can be short grooves, which limit tool 10 to a given location or to a finite set of locations. Preferably, hollows 26 can be longer, uniformly spaced grooves in a support that allow tool 10 to be slid along the length of the grooves. The hollows can be long enough to hold three or more tools simultaneously. Thus, the hollows can exceed 0.5 m in length. This allows multiple tools to be queued up, used, or stored in an orderly manner.

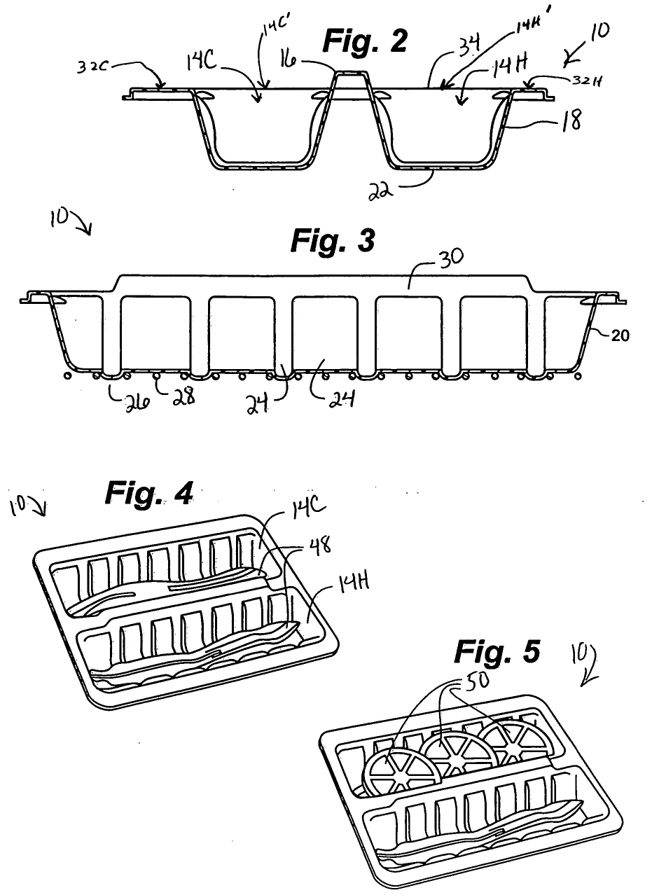

Cavities 14C, 14H may be of any size. To ensure greater consistency in the amount of sandwich garnish used, it is preferred that cavities 14C, 14H have a volume approximately equal to the desired volume of sandwich garnish to be used. Alternatively cavities 14C, 14H may have an indicium or indicia 30 indicating the desired volume or level of sandwich garnish to be used. Indicium 30 may be a groove, a rib, the top of a protrusion as illustrated in FIGS. 1 and 3, or any other kind of suitable indicator. In a preferred embodiment, the capacity of cavities 14C, 14H is in the range of from about 100 to about 375 cubic centimeters. In a most preferred embodiment as illustrated in FIGS. 1-14, cavities 14C, 14H have a capacity of approximately 230 ml. Bread component B for which the most preferred embodiment of FIGS. 1-14 has been optimized is a roll B that is approximately 5.1 centimeters tall, 7.6 centimeters wide, and 16 centimeters long with a hinge thickness of approximately 2.5 centimeters. Top or crown half C and bottom or heel half H of roll B are approximately the same size. Cavities 14C, 14H may be labeled or have indicia thereon or adjacent thereto with, for example, “Crown” and “Heel” (for the crown and heel of the roll that is to be placed adjacent thereto, respectively). Cavities 14C, 14H may have different capacities. In that case, it may be important to have indicators 32C (“Crown”), 32H (“Heel”) for cavities 14C, 14H, respectively. As shown in FIGS. 1 and 2, indicators 32C and 32H are located on the peripheral planar portion 33 that is adjacent and in substantially the same plane as cavity openings 14C′ and 14H′ of openings 14C and 14H, respectively, and planar portion 33 may have a width as desired, for example, from about 0.25 to about 2 inches. Indicators 32C and 32H allow cavities 14C (crown) and 14H (heel) to be matched up easily to heel H and crown C of bread component B.

Preferably, cavities 14C, 14H have an opening whose shape is similar to bread component B. For example, for sub roll B, the preferred shape of the openings 34 of cavities 14C, 14H is elongated, in this case rectangular. In a most preferred embodiment, opening 34 is approximately 17 centimeters long (along the elongated dimension) and 5.2 centimeters wide. Preferably, opening 34 is approximately the same size as bread component B minus the area occupied by the hinge 12. For applying garnishes to both sides of a sub roll B, preferably tool 10 has two elongated cavities 14C, 14H whose elongated axes are substantially parallel to each other. If the elongated axis is more than about 20% longer than the perpendicular axis, the opening is considered elongated. If the opening is rectangular and the elongated axis is less than about 20% longer than the perpendicular axis, the opening is considered to be generally square. Thus, the length of tool 10 may be slightly longer or shorter than the length of the bread component. Typically, the bread component will be slightly longer than the length of the tool.

Sandwich assembly tool 10 adapted for sub roll B preferably has a raised ridge 16 between cavities 14C and 14H. Preferably, ridge 16 has a height in the range of from about 2 millimeters to about 20 millimeters, a width in the range of from about 5 millimeters to about 17 millimeters, and a length in the range of from about 5 centimeters to about 25 centimeters. In a most preferred embodiment, ridge 16 has a height of about 5 millimeters, and narrows slightly from bottom to top having a ridge width of about 1.5 centimeters, to about 1.2 centimeters at the top and at the base a width of approximately 1.3 centimeters at mid-height level, and a length of about 12.5 centimeters at mid-height level. Ridge 16 is meant to be placed against hinge 12 of sub roll B or similar bread component B while tool 10 is inverted over bread component B in order to place sandwich garnish 36 onto bread component B. Thus, ridge 16 prevents sandwich garnish 36 and condiment from entering hinge 12 of roll B and prevents garnish 36 in heel cavity 14H from being placed on crown C of roll B. Ridge 16 preferably extends substantially the length of hinge 12. Ridge 16 provides several benefits. First, it provides a neater appearance. Second, it prevents garnish from accumulating in hinge 12, which may obstruct the closing of bread component B. Third, it allows filling 38 and garnish 36 to be better distributed so that biting into sandwich S does not result in a mouthful of bread B and sandwich garnish 36, but no sandwich filling 38.

Alternate Sandwich Assembly Tools

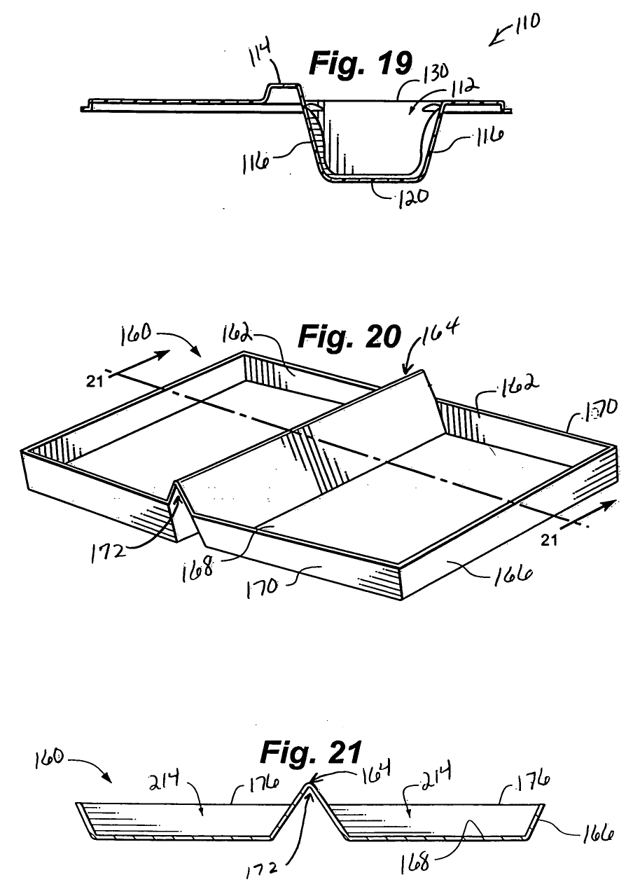

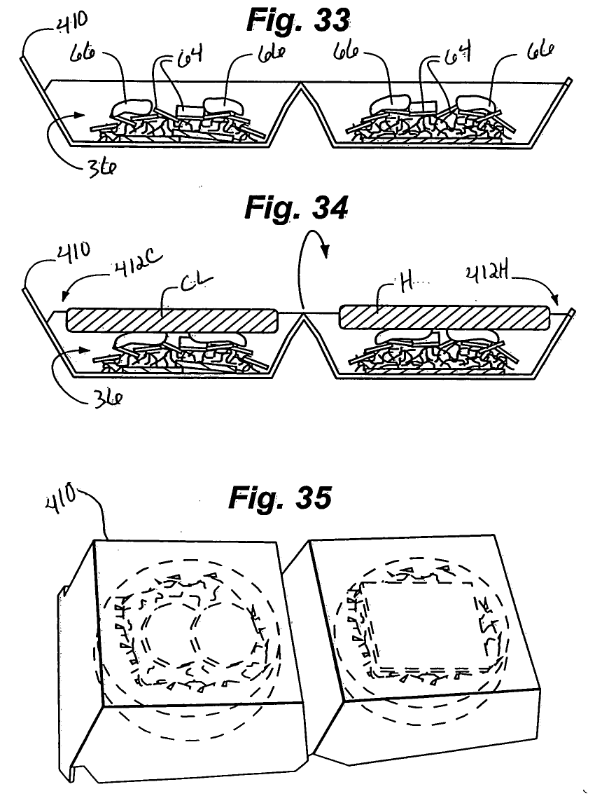

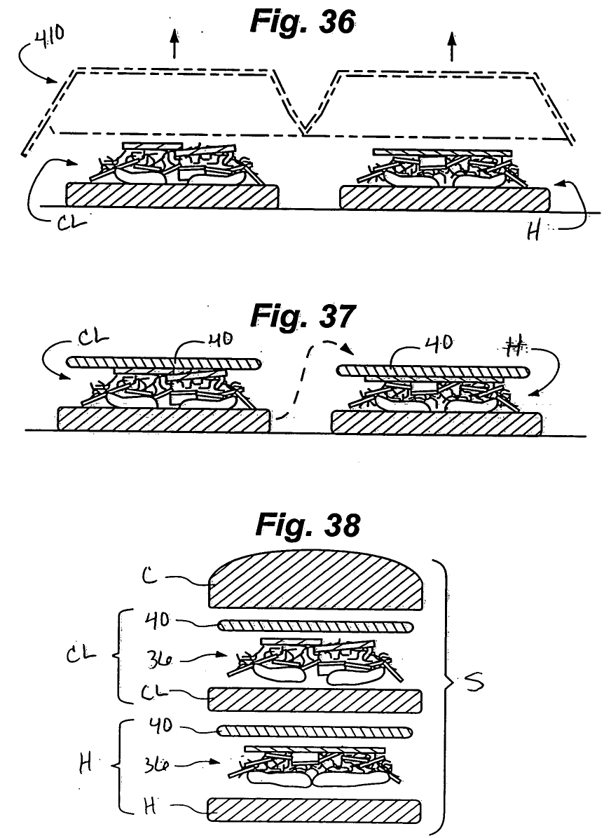

FIGS. 18-41 and 51-52 illustrate other embodiments of sandwich assembly tools in accordance with the invention. As shown in FIGS. 18-19, a first alternate embodiment of sandwich assembly tool 110 has a single cavity 112, a ridge 114, sidewalls 116, end walls 118, bottom wall 120 and a plurality of protrusions 122 and 124. Tool 110 also includes a flat platform area 126 against which may rest a heel or crown portion of a bread component, for example, a bun or a roll where no condiment or garnish is to be applied. Opening 130 has a generally elongated rectangular shape. This embodiment is adapted for applying garnish to, for example, a heel or crown of a split roll or one half of a hot dog bun.

As shown in FIGS. 20-21, a second alternate embodiment of a sandwich assembly tool 160 has two cavities 162 and ridge 164, sidewalls 166, bottom walls 168, end walls 170 and hinge 172 that defines a ridge 164. Opening 176 is generally square. This embodiment is readily made from any suitable material, such as cardboard, paperboard or a rigid or semi-rigid foam material, and may also function as the container for the completed sandwich. Thus, the method in accordance with one aspect of the invention allows the sandwich to be assembled in the sandwich container that is provided to the consumer of the sandwich. This embodiment is adapted for applying garnish to, for example, both halves of a split roll or a hot dog bun.

As shown in FIGS. 22-23, a third alternate embodiment of sandwich assembly tool 210 has two cavities 212, but no protruding ridge. Cavities 212 have an oval elongated opening 214. Cavities 212 have protrusions 216 that are rib like. This embodiment is adapted for applying garnish to both halves of a sub-type roll. For example, the protrusions may be relatively thin or relatively wide. The protrusions could also be round, for example. The protrusions can provide rigidity and strength to the sandwich assembly tool without adding significant weight.

As shown in FIGS. 24-25, a fourth alternate embodiment of sandwich assembly tool 260 has two cavities 262 and ridge 264. Cavities 262 have an elongated rectangular opening 266. This embodiment is adapted for applying garnish to both halves of a sub-type roll.

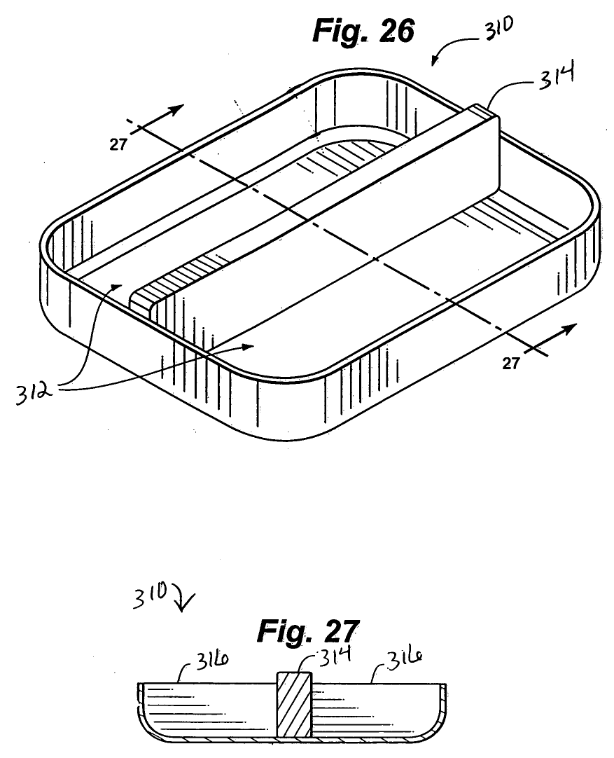

As shown in FIGS. 26-27, a fifth alternate embodiment of sandwich assembly tool 310 has two cavities 312 and ridge 314. Cavities 312 have an elongated, generally rectangular opening 316. This embodiment is adapted for applying garnish to both halves of a sub-type roll.

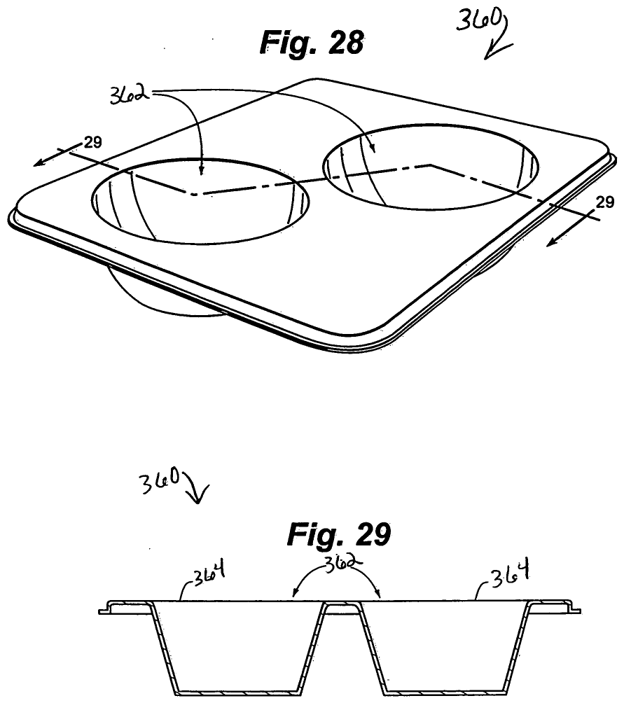

As shown in FIGS. 28-29, a sixth alternate embodiment of sandwich assembly tool 360 has two cavities 362, but no ridge. Cavities 362 have a circular opening 364. This embodiment is adapted for applying garnish to a circular bun that has no hinge, or in other words has two separated halves.

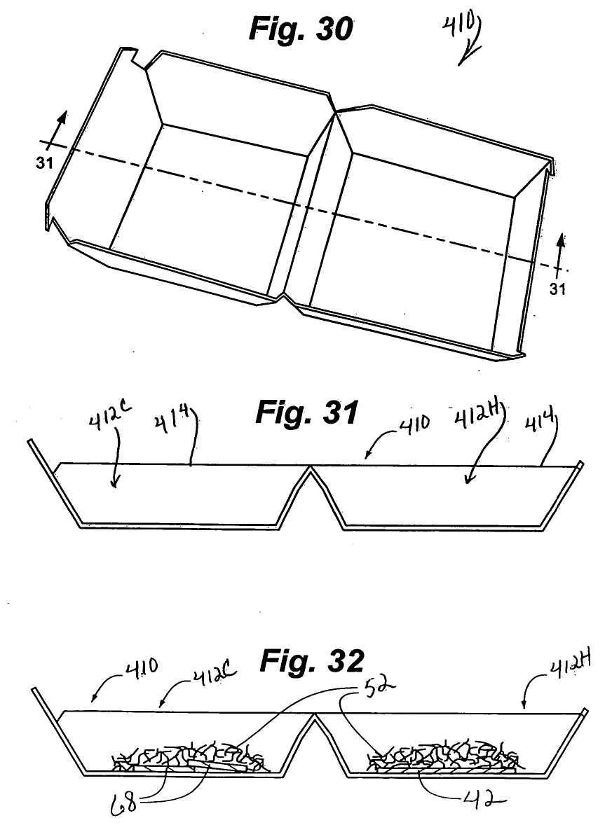

As shown in FIGS. 30-31, a seventh alternate embodiment of sandwich assembly tool 410 has two cavities 412C, 412H, but no ridge. Cavities 412C, 412H have a square opening 414. This embodiment can be made of any material, now or hereafter developed. For example, the material includes, but is not limited to, polystyrene foam; corrugated or plain cardboard; single-ply, multi-ply, and corrugated paperboard; clear plastic; earth shell which is a foam made from calcium carbonate, wood fiber, and starch. This embodiment can be used for packaging completed sandwich S in which case the tool does not have to be designed for long-term use. This embodiment is adapted for a bun that has no hinge, or in other words has two separated halves. This embodiment is particularly adapted for making hamburgers and cheeseburgers.

As shown in FIGS. 51-52, an eighth alternate embodiment of sandwich assembly tool 460 has one cavity 462 and no ridge. Cavity 462 has an elongated rectangular opening 464. Tool 460 can be used for sandwiches where garnish is applied to one half of a bun, typically crown C. Also two tools 460 can be used in combination when hot and cold garnishes 36 are applied to different halves of bread product B.

Method of Making a Toasted Deli-Style Sandwich

Reference should be made to FIGS. 1-17 for this example.

In response to a customer order, roll B is opened and suitably toasted, such as by placing on the conveyor of a toaster (not shown). Preferably, the toaster toasts using both hot air impinging on roll B and infrared heaters to achieve toasting times substantially less then a minute to minimize customer wait times. While roll B is toasting, a preassembled sandwich filling 38 is suitably heated, by, for example, heating in a flash steamer (not shown). Preassembled sandwich filling 38 generally has at least one layer of meat 40 and one layer of cheese 42 covering approximately one half of the layer of meat. It is to be understood that in general the sandwich filling may be composed of any desired material and may be composed of, for example, cheese, meat, vegetables, eggs and any combination thereof. Generally, meat 40 has already been cooked so meat 40 only requires heating. However, heating can include cooking. To ease handling, preassembled sandwich fillings 38 are separated from each other by a separator layer 44 that typically is larger than filling 38. The larger size of separator 44 allows it to be easily handled and peeled away. If desired, separator 44 may be a good conductor of heat so that separator 44 does not significantly slow the heating of filling 38. Separator 44 may be any suitable material as desired and may be, for example, aluminum foil, parchment paper, coated paper, polymer sheet or film, for example.

Flash steamers are well known in the art. The steamer has a drawer. When the drawer is closed, steam is created by flashing water off of the hot bottom of the drawer. The steam heats the sandwich filling to a desired temperature, which may be in the range of from about 120 to 110° F. relatively quickly, such as in less than about 30 seconds and more preferably in less than about 25 seconds and most preferably as quickly as possible.

While roll B is being toasted and sandwich filling 38 steamed, sandwich garnishes 36 and condiments 46 are assembled or an assembled sandwich garnish 36 is retrieved from storage. Preferably sandwich garnishes 36 are assembled in a sandwich assembly tool 10 adapted to the assembly of sandwich garnishes 36 for a specific bread component B. Most preferably, the preferred embodiment of tool 10 as described earlier is used. A variety of different sandwich garnishes and condiments can be assembled in the sandwich assembly tool depending on the type of sandwich being made. If there is a preferred order for the sandwich garnishes when a sandwich is prepared sequentially, that order is inverted when using tool 10. For example, if it is desired that the lettuce be on top of a sliced tomato in completed sandwich S, the lettuce is placed first in the sandwich assembly tool and the tomato on top of the lettuce. Generally, condiments 46 are placed on top of assembled sandwich garnishes 36 because condiments will tend to stick to sandwich assembly tool 10. If the assembled sandwich garnishes 36 are to be stored for later use and stacked on top of each other, it may be preferable to apply the condiments 46 after the assembled sandwich garnishes 36 are retrieved from storage if the condiment is likely to contact the bottom of another sandwich assembly tool during storage.

Assembling a Toasted Turkey BLT sandwich will now be described with reference to FIGS. 4-17. In crown cavity 14C of tool 10, sliced pre-cooked bacon 48, sliced tomatoes 50, and sliced lettuce 52 are placed in order. In heel cavity 14H, bacon 48 and lettuce 52 are placed in order. Mayonnaise 54 is applied to assembled sandwich garnish 36 in both cavities 14C, 14H. Next toasted roll B is placed on and aligned with tool 10 with ridge 16 placed against hinge 12 of roll B and heel side H of roll B over heel cavity 14H. The food worker then inverts sandwich assembly tool 10 shown generally by arrow X in FIGS. 8-10, where the garnish and condiments fall by gravity onto roll B after inversion. Thereafter, the food worker removes sandwich assembly tool 10 leaving the assembly as shown in FIG. 11.

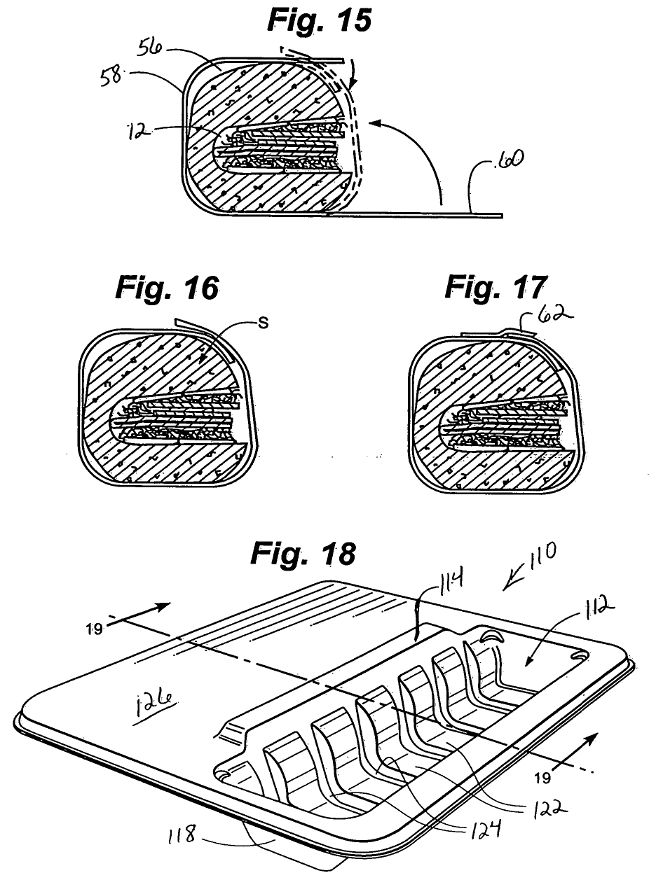

In general, the food worker removes the sandwich filling 38, which may be cold or unheated, from a refrigerated source, for example, from the flash steamer and places it on top of sandwich S optionally with cheese 42 over crown C and separator layer 44 away from sandwich S, as shown in FIG. 12. The food worker wedges sandwich filling 38 against hinge 12 of roll B as shown in FIG. 12A and discards separator layer 44. As illustrated in FIGS. 15-17, completed sandwich S is then closed, placed into the pouch 56 of a wrapper 58, loosely wrapped in a wrap sheet 60 of wrapper 58, and sealed with a sticker 62, which identifies sandwich S, and served to the customer who ordered sandwich S.

Method of Making Various Toasted Deli-Style Sandwiches

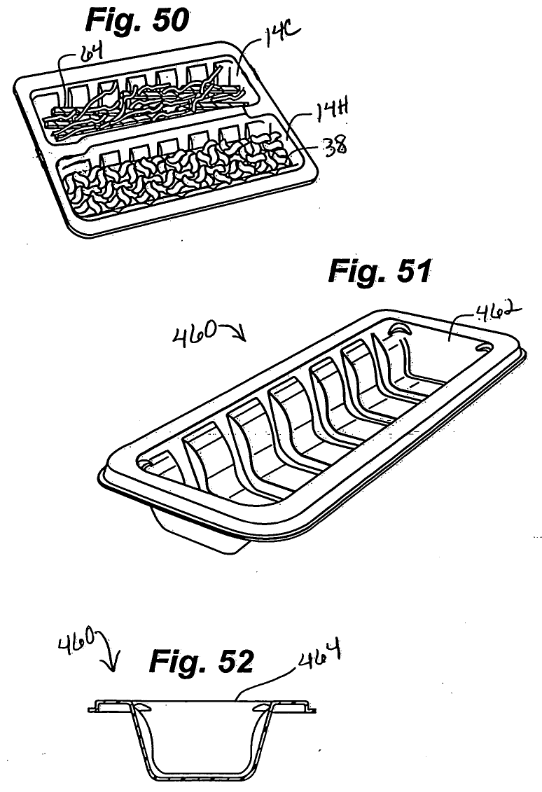

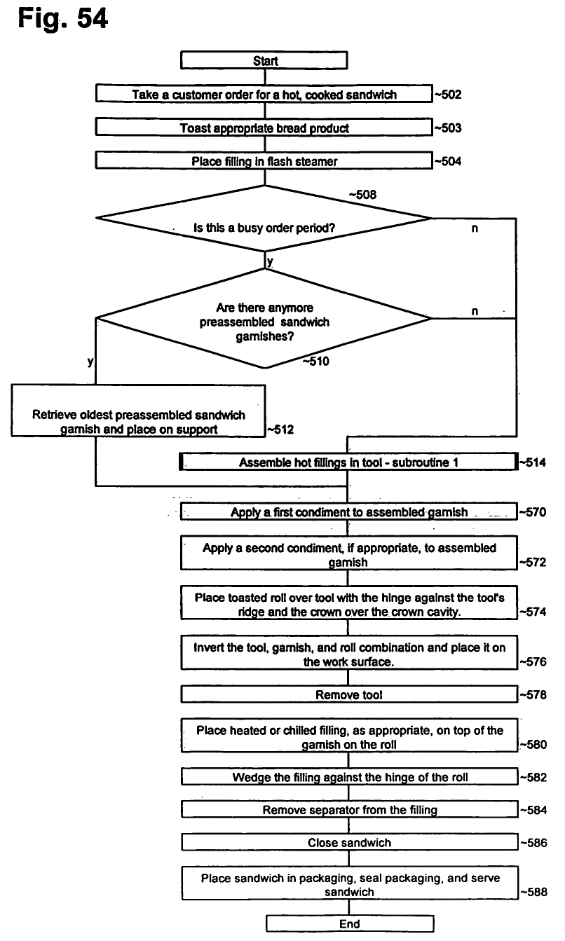

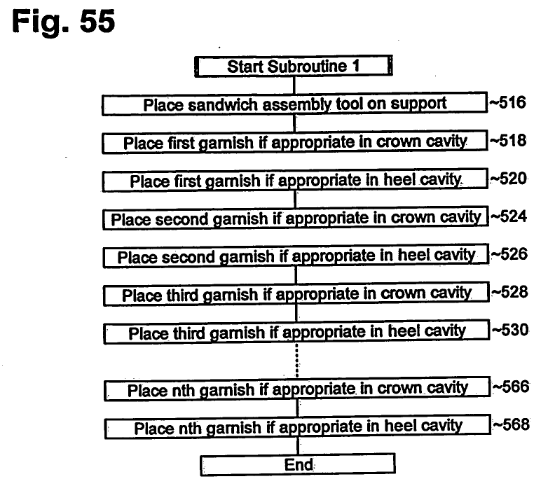

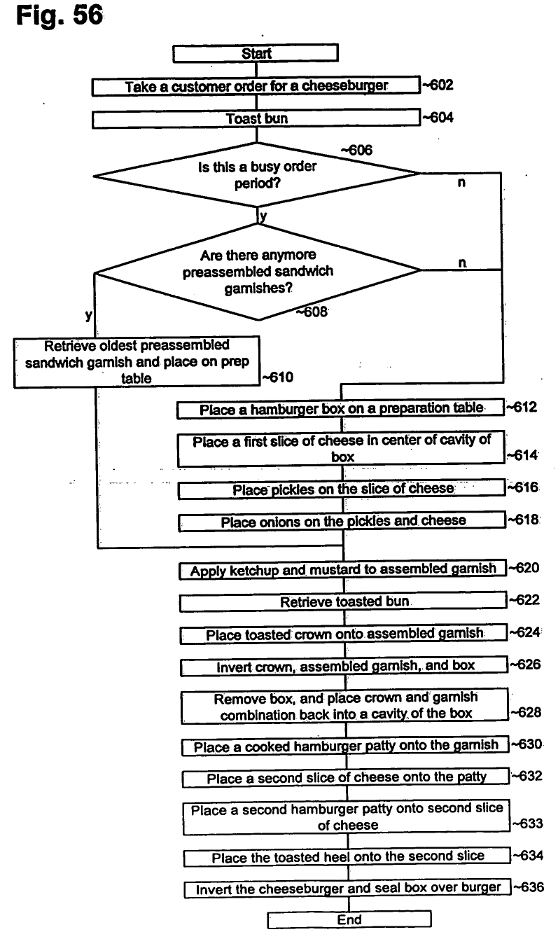

A method of making a toasted Italian sub- or hero-type sandwich will be described with reference to FIGS. 50-51 and 54-55. FIGS. 50-51 and 54-55 are generic because they apply to many different sandwiches even though the ingredients for each sandwich vary. In step 502, an order for an Italian sub-type sandwich is taken. In step 503, a french roll is opened and placed on the conveyor of a toaster. While the roll is toasting, a preassembled sandwich filling is placed in a flash steamer in step 504. For this sandwich, the preassembled sandwich filling has several slices of each of ham, salami, mortadella, and provolone cheese and a separator sheet. The cheese may be sliced, shredded, diced, liquid or grated and, for example, a slice or slices of provolone are layered on only one side of the sandwich filling. While the filling is being steamed, a decision has to be made whether an assembled sandwich garnish should be retrieved or the sandwich garnish should be assembled.

If the order arrives during a busy period, an assembled sandwich garnish is retrieved, if there are any, in step 512. If not, the sandwich garnish is assembled in the tool. In step 516, an assembly tool is placed on a support. In step 518, a first garnish is placed in the crown cavity of the tool. For a toasted Italian sub-type sandwich, sliced tomatoes are placed in the crown cavity in step 518. Because tomatoes can be optional or not used in the recipe below, the sandwich filling in the completed sandwich, step 520 would be omitted. In step 520, giardinera is placed in the heel cavity. Nothing occurs in steps 524 and 526. In step 526, onions are placed in the heel cavity. Nothing occurs in step 530. The fourth and final garnish to be used is lettuce. Lettuce is placed in the crown and heel cavities in steps 566 and 568.

Next, Italian dressing is applied to the garnish in both cavities in step 570. There is no second condiment in this recipe, so nothing occurs in step 572. Next, the toasted roll is placed on the tool with the hinge against the ridge and the crown of the roll over the crown cavity in step 574. In steps 576 and 578, the food worker inverts and removes tool 10. In step 580, the food worker removes the heated sandwich filling from the flash steamer and places it on top of sandwich with the cheese over the crown and the separator layer on top. In steps 582 and 584, the food worker wedges the sandwich filling against the hinge of the roll and removes and discards the separator layer. In steps 586, 588, the completed sandwich is then closed, wrapped, sealed and served to the customer.

A method of making a beef sandwich will be described below. In response to a customer order, french roll B is opened and placed on the conveyor of a toaster. While roll B is toasted, preassembled sandwich filling 38 is placed in a flash steamer (not shown). Preassembled sandwich filling 38 has several slices of both roast beef and provolone cheese. While filling 38 is steaming and roll B is being toasted, sandwich garnish 36 can be assembled or a preassembled sandwich garnish 36 can be retrieved from chilled storage. Sandwich garnish 36 is assembled or pre-assembled by placing in order giardinera and lettuce in crown cavity 14C and onions and lettuce in heel cavity 14H of tool 10. Next, Italian dressing is applied to garnish 36 in both cavities. Next, toasted roll B is placed on and aligned with tool 10 with ridge 16 placed against hinge 12 of roll B and heel side H of roll B over heel cavity 14H. Then the food worker inverts and removes tool 10. The food worker removes heated sandwich filling 38 from the flash steamer and places it on top of sandwich S with cheese 42 over crown C and separator layer 44 away from sandwich S. The food worker wedges sandwich filling 38 against hinge 12 of roll B and removes and discards separator layer 44. Completed sandwich S is then closed, wrapped, sealed and served to the customer.

A method of making a reuben-style sandwich will be described below. In response to a customer order, a rye roll B is opened and placed on the conveyor of a toaster. While roll B is toasted, preassembled sandwich filling 38 is placed in a flash steamer (not shown). Preassembled sandwich filling 38 has several slices of both meat and swiss cheese. The meat can be turkey or corned beef. On one half of the filling is swiss cheese and on the other is sauerkraut. Next, reuben sauce is applied to both halves of toasted roll B. The food worker then removes heated sandwich filling 38 from the flash steamer and places it on top of roll B with cheese 42 over crown C and separator layer 44 away from sandwich S. The food worker wedges sandwich filling 38 against hinge 12 of roll B and removes and discards separator layer 44. Completed sandwich S is then closed, wrapped, sealed and served to the customer.

Method of Making a Two Patty Hamburger Sandwich with a Middle Layer of Bread

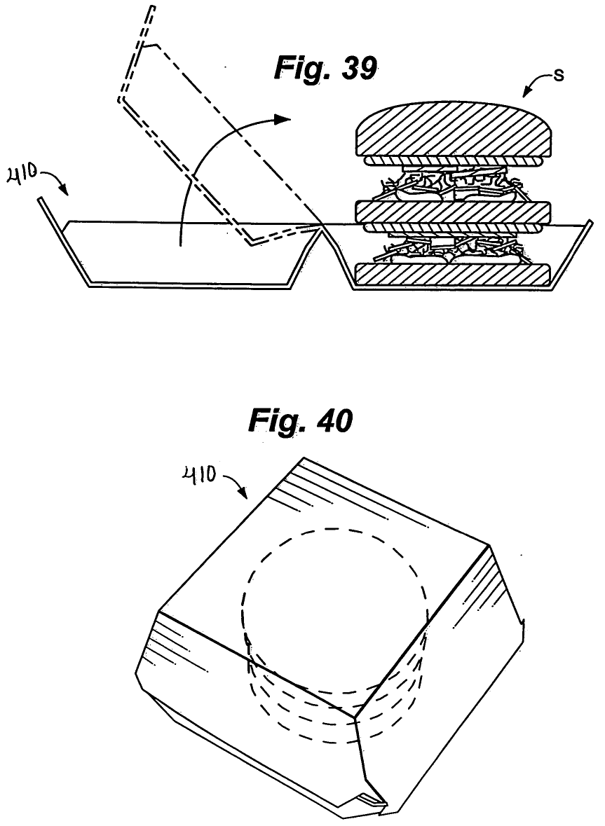

A method of making a two patty hamburger sandwich with a middle layer of bread will be explained with reference to FIGS. 32-40. A food worker places sandwich assembly tool 410 on a table right side up. The food worker places, in order of insertion, first a slice of cheese 42, then shredded lettuce 52, then onions 64, and finally sauce 66 in heel cavity 412H, and, in order of insertion, sliced pickles 68, lettuce 52, onions 64, and sauce 66 in crown cavity 412C. Assembled sandwich garnish 36 can be used immediately to make a sandwich S that has been ordered or it may be stored in a chilled storage area if desired, which is most preferably maintained at 33-40° F. for later use. In response to an order from a customer, the food worker begins toasting hamburger bun B that includes a crown C, a club CL, and a heel H. While bun B is toasting, sandwich garnish 36 can be assembled or an assembled sandwich garnish 36 can be retrieved from chilled storage. Next toasted heel H is put on top of assembled sandwich garnish 36 in heel cavity 412H and toasted club CL is put on top of assembled sandwich garnish 36 in crown cavity 412C. Next sandwich assembly tool 410 is inverted while club CL and heel H are held on top of assembled sandwich garnishes 36. Tool 410 is removed or dressed heel H and dressed club CL are placed into tool 410 for further assembly (not shown). Next, a cooked meat patty 40 is added to the top of dressed heel H and another cooked patty 40 to dressed club CL. Patty 40 can be a patty that has been grilled on a griddle or broiled in a broiler that has a conveyor. Patty 40 can be cooked to order, or cooked and stored in a heated storage area that is designed to keep patty 40 hot without drying it out as is well known in the art. Dressed club CL is then stacked on dressed heel H. Finally, hamburger S is completed by placing crown C on top. If sandwich assembly tool 410 was a hamburger sandwich container such as a clamshell container as illustrated in FIGS. 30-36, hamburger S can be placed inside container 410 as illustrated in FIG. 39, and container 410 can be closed and given to the customer who ordered the sandwich.

Method of Making a Hamburger Sandwich with Cheese

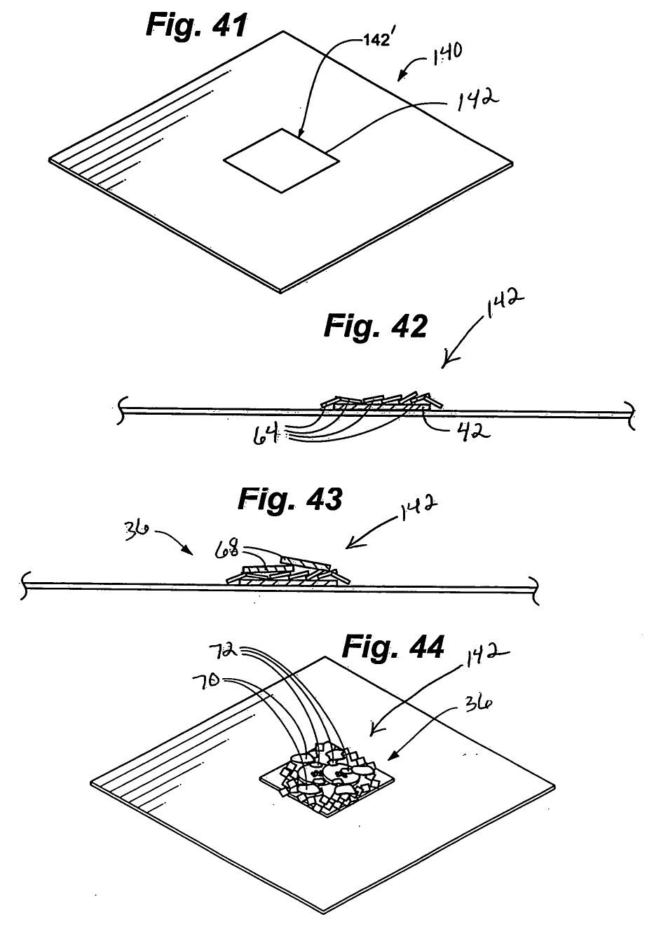

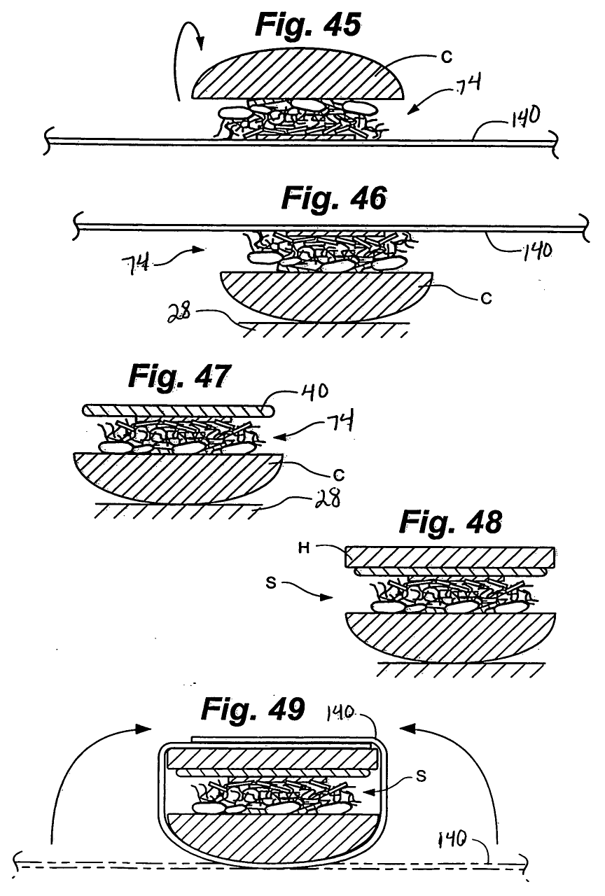

A method of making a hamburger sandwich with cheese having a single hamburger patty 40 will be explained with reference to FIGS. 41-49. A food worker stacks, in order, cheese 42, onions 64, and a sliced pickle 68 on a staging area 142 of a hamburger sandwich wrapper 140. The staging area may be marked by indicia 14Z as shown in FIG. 41 to assist the person who assembles the sandwich. Alternatively, for example, a sandwich assembly tool in accordance with the invention may be utilized, such as sandwich assembly tool 10 with a cavity, or in a clamshell sandwich container or box. Sandwich assembly tool 10 is generally preferred for use if assembled sandwich garnish 36 will be stored for later use. Wrapper 140 is preferred if assembled sandwich garnish 36 will be used immediately. In response to an order, the food worker begins toasting crown C and heel H of a hamburger bun B (not shown). While bun B is toasting, sandwich garnish 36 can be combined as described earlier or an assembled sandwich garnish 36 can be retrieved from chilled storage. Next ketchup 70 and mustard 72 is applied to sandwich garnish combination 36. Next toasted crown C is put on top of combined sandwich garnish 36. Then the bread and sandwich garnish combination 74 is inverted while the food worker presses the crown C and the wrapper 140 or sandwich assembly tool 10 together. For a breadless sandwich leaf lettuce may be substituted for the bread crown and heel. Thus, in this sense the term “bread” or “bread component” also includes leaf lettuce or similar materials used as or in place of bread or a bread component. Inverted bread and sandwich garnish combination 74 can be placed onto a support 28 or onto hamburger wrapper 140. Then single cooked meat patty 40 is added to top of bread and sandwich garnish combination 74. Next, toasted heel H is placed on top of patty 40 and completed sandwich S is wrapped in wrapper 140 and inverted.

Method of Making a Hamburger Sandwich with Two Hamburger Patties and Cheese

A method of making a hamburger sandwich with two hamburger patties and two slices of cheese will be explained with reference to FIG. 56. In step 602, an order for a double cheeseburger sandwich is taken. In step 604, a french roll is opened and placed on the conveyor of a toaster. If the order arrives during a busy period, an assembled sandwich garnish is retrieved, if there are any, in step 610.

If not, the sandwich garnish is assembled in the tool. In step 612, a hamburger clamshell container or box is placed on a support. In steps 614, 616 and 618, a food worker stacks a first slice of cheese, sliced pickles and sliced onions in one cavity of the box. In step 620, ketchup and mustard are added. In steps 622 and 624, the toasted bun is retrieved from the toaster and the toasted crown is put on top of the sandwich garnish assembled in the hamburger box. Then the box and contents are inverted while the food worker presses the crown and the box together in step 626. In step 628, the box is removed, placed on the support, and the crown and garnish combination placed in the box. In steps 630 and 632, a cooked meat patty, a second slice of cheese followed by a second patty in step 633 are placed on top of the crown and garnish combination. Next the toasted heel is placed on top of the second slice of cheese in step 634. In step 636, the sandwich is inverted and the box is sealed over the sandwich.

As can be appreciated, similar sandwiches can be made by replacing the hamburger patties with a single hamburger patty, cheese, a chicken patty, a chicken breast filet, a fish patty, a veggie burger patty, etc. to make cheese sandwiches, chicken sandwiches, fish sandwiches, veggie burgers, etc.

Method of Making a Hot Dog

A method of making a Chicago-style hot dog will be described. When an order is received, a bun is placed in a heating device, preferably a grill or a toaster. Cooking of the hot dog may also be started at that time or it may be heated in advance. While the bun is heated or in advance of the order, chopped cucumber, hot peppers, onions, tomatoes, celery salt, and a dill pickle spear is placed into the cavity of a tool. Yellow ballpark mustard is applied onto the assembled garnish in the cavity. When the bun and hot dog are sufficiently heated, the hot dog is placed into the bun and the tool is inverted onto the bun and the hot dog. The hot dog is closed, packaged, and served to a consumer.

Method of Making a Hot Sandwich with Hot Garnishes

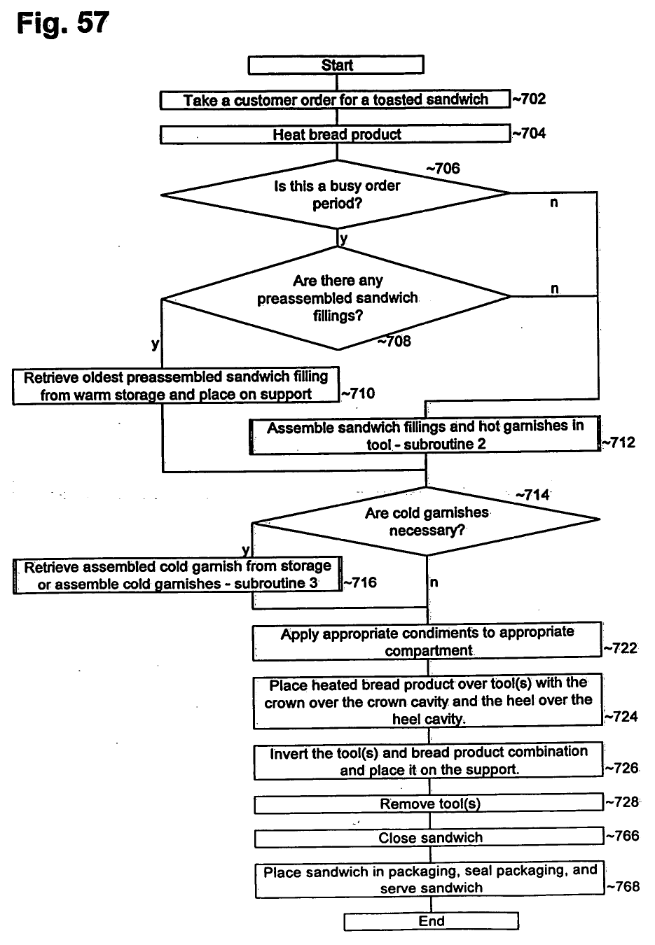

A method for making a hot sandwich with hot garnishes a tool will be described with reference to FIGS. 57-59. Hot garnishes commonly used in sandwiches include grilled peppers, grilled onions, sauerkraut, cabbage, and chili. This list is not meant to limit the kinds of garnishes that can be served hot.

The method will be illustrated by showing how an Italian beef sandwich, an Italian sausage sandwich, and a diced chicken sandwich can be made. In step 702, a customer places an order for one of these three sandwiches. In response, heating of a bread product for the sandwich begins in step 704. Toasting is generally preferred so that the bread product has a toasted texture. If the order was placed during a busy order period and preassembled fillings are available, the preassembled filling is retrieved from storage in step 710. Preferably the storage area is heated. The heated storage or holding area may be heated in any suitable manner, such as, for example, but is not limited to, a holding area heated by heat lamps, an oven, or a heated holding cabinet. Preferably the storage area is maintained at a temperature of 140 to 210° F.

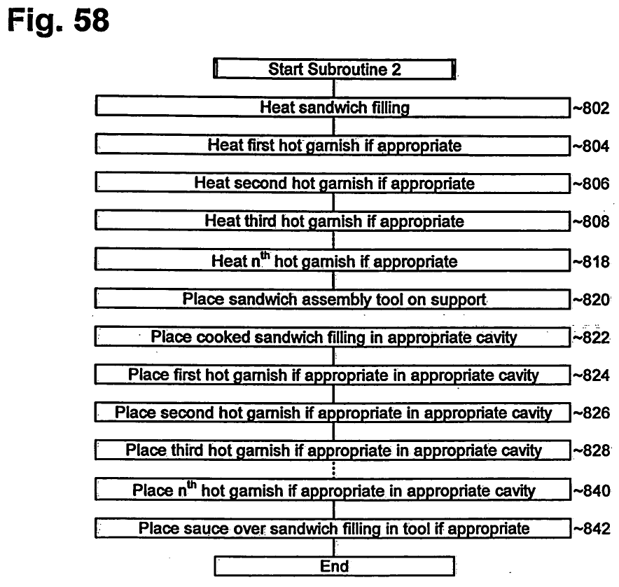

If the order was not placed during a busy order period or preassembled fillings are unavailable, a filling has to be made. The assembly of the filling is described in FIG. 58. The assembly of the filling is generally very similar to the preassembly of the filling. In fact, if preassembled sandwich fillings run out, it may be optimal to simultaneously prepare sandwich fillings for immediate use and for storage.

Assembly of a sandwich filling for an Italian beef sandwich will be described first. First the sandwich filling has to be heated in step 802. This step may involve simmering pre-cooked and pre-sliced beef in “au jus” or beef stock. In step 804, strips of sweet pepper are grilled, typically on a grill common in restaurants. Because no other hot garnishes are usually in an Italian beef sandwich, nothing occurs in steps 806, 808 and 818. In step 820, a tool with two cavities is placed on a support. In step 822, the heated Italian beef is placed in the heel cavity. In step 824, the grilled peppers are placed in the crown cavity. Because no other hot garnishes are required in this recipe, nothing occurs in steps 826, 828 and 840. In step 842, some “au jus” is poured over the Italian beef in the heel cavity.

Assembly of a sandwich filling for an Italian sausage sandwich will be described second. First the sandwich filling has to be heated in step 802. In this step, Italian sausage is grilled. In steps 804-806, strips of sweet pepper and slices of onion are grilled or sautéed until soft. Because no other hot garnishes are required, nothing occurs in steps 808 to 818. In step 820, a tool with two cavities is placed on a support. In step 822, the grilled sausage is placed in the heel cavity of the tool. In steps 824 and 826, the grilled peppers and onions are placed in the crown cavity. Because no other hot garnishes are required in this recipe, nothing occurs in steps 828 to 840. Nothing occurs in step 842 because no hot condiments are used for this sandwich.

Assembly of a sandwich filling for a diced chicken sandwich will now be described. First the sandwich filling has to be heated in step 802. In this step, diced chicken is cooked on the grill. In step 804, onions are cooked on the grill. It is preferable in the cooking process if the chicken and onions are mixed and cooked together. Alternatively, the chicken, sausage, onions, or any other food component may be precooked, in which case only heating is needed if the sandwich filling is to be heated. Because no other hot garnishes are used, nothing occurs in steps 806 to 818. In step 820, a tool with one or two cavities is placed on a support. If a single cavity tool is used it is preferred that it be similar to the embodiment illustrated in FIGS. 51-52. A tool with two cavities may be preferred when the chicken is being cooked to order. A single cavity tool may be preferred when the chicken is being cooked and stored for later use. In steps 822 and 824, the diced chicken and grilled onion mixture is placed in the heel cavity of the tool. Because no other hot garnishes are required in this recipe, nothing occurs in steps 826 to 840. In step 842, a sauce is poured over the chicken in the heel cavity.

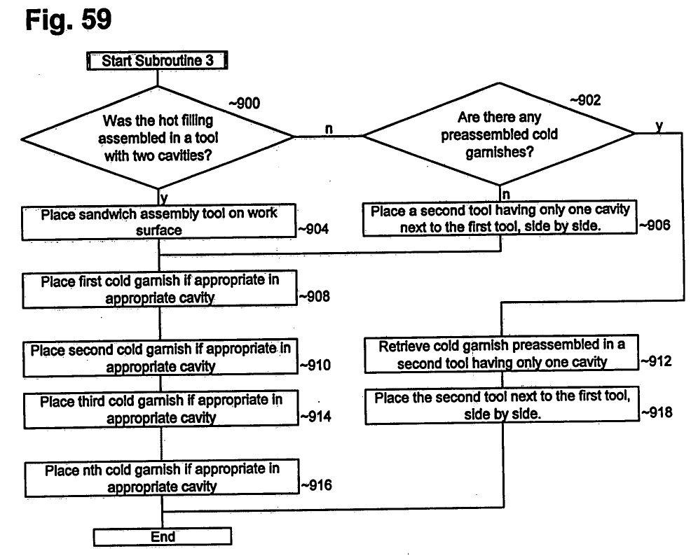

Returning to FIG. 57, a tool with hot fillings and garnish has been placed on the support in step 710 or 712. The diced chicken sandwich requires cold garnishes (step 714) so a cold garnish has to be assembled (step 716). The Italian beef and Italian sausage sandwiches ordinarily do not use cold garnishes. Assembly of the cold garnish will be described with reference to FIG. 59. If the diced chicken was assembled in a tool with one cavity and there are preassembled cold garnishes available (steps 900 and 902), a cold garnish is retrieved from storage and placed side by side with the tool containing the diced chicken in steps 912 and 918.

If not, the cold garnish has to be assembled using either a new single cavity tool or the tool containing the diced chicken if it has two cavities (steps 900-906). In steps 908, 910, and 914, shredded lettuce, tomato, and cucumber are placed sequentially into the crown cavity.

Returning to FIG. 57, cold and hot garnishes have been assembled as appropriate. In step 722, appropriate condiments are applied to the contents of the cavities. Alternatively, the condiments could be applied to the assembled sandwich or the consumer could be allowed to apply his preferred condiments to the completed sandwich. For the Italian sandwiches, appropriate condiments include mustard and ketchup. For the diced chicken sandwich, a mint yoghurt sauce or other condiments are applied to the cucumbers in the crown cavity.

In step 724, the toasted bread product is placed over the tool or tools with the crown over the crown cavity and the heel over the heel cavity. If the bread product has a hinge and the tool has a ridge then the hinge is placed against the ridge. In steps 726-768, the tool and bread product are inverted; the tool removed; the sandwich closed, packaged, sealed and served to the customer.

Method of Making an Egg Sandwich

A method of making an egg sandwich will be described. Eggs are cooked. They can be cooked omelet style and folded or sunny side up in a mold to minimize the footprint of the egg filling. Slices of Canadian or regular bacon are cooked. When the cooking is completed, the bacon is placed on top of the eggs. Then a slice of cheese is added to the top. Alternatively, the egg is placed on top of the bacon and then the cheese is placed over the egg. The egg combination is then transferred to a hot holding area. Often the combination is completed in advance of a busy order period in sufficient number in advance of a particular order.

After an order is received, a bread product is toasted or is obtained from a hot holding cabinet. The bread product may be a muffin. An egg combination is taken from the hot holding area and placed on wrapper, box, or tool 10 with the cavity facing-up. The crown of the bread product is placed on the egg combination. The bread and egg combination is inverted. The heel is placed on top of the combination and the completed sandwich is packaged and inverted. If a wrapper or box was used during the assembly, it is preferable that the wrapper or box be used to package the completed egg sandwich.

Methods of Making Novelty and Cocktail Sandwiches

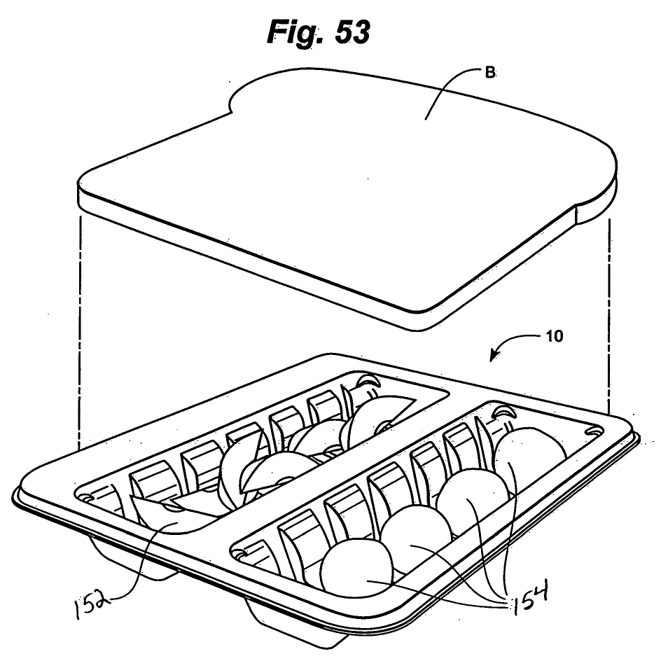

Methods of making novelty and cocktail sandwiches will be explained with reference to FIG. 53. Tool 10 with two cavities can have contents in one cavity that are not meant to be mixed with the contents of the other cavity. For example, a “baked Alaska” sandwich can be made by putting hot jam or fruit 152 in one cavity and ice cream or another material 154 in the other cavity. A slice of bread B, which could be suitably configured and sweetened for a dessert, could be placed over both cavities as illustrated in FIG. 53. The tool and bread could be inverted and a second slice of bread placed on top.

Alternatively, cocktail sandwiches can be made. Cocktail sandwiches are typically quite small. All the cavities of tool 10 could be filled with the same garnishes, condiments, and fillings. Like the baked Alaska sandwich, a first slice of bread could be placed over the tool, the combination inverted, and a second slice of bread placed on top. Finally the larger sandwich can be cut up into smaller pieces. Preferably the tool would have four or nine generally square cavities arranged in a matrix. The tool offers great efficiencies for making cocktail sandwiches because the sandwiches can be assembled simultaneously rather than sequentially.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

1. A method of filling an order for a sandwich comprising:
toasting a bread component for the sandwich for less than about 1 minute in response to the order in a first heating device; and
initiating and completing the heating of a sandwich filling for the sandwich from about 40° F. or less to about 120° F. or more in a second heating device, while the bread component is heating, in response to the order.

2. The method of claim 1 herein the second heating device is a flash steamer.

3. The method of claim 1 wherein the first heating device is a conveyor toaster.

4. The method of claim 1 wherein the sandwich filling is heated within 20 seconds.

5. The method of claim 1 further comprising combining a condiment with a sandwich garnish and placing the bread component onto the condiment and sandwich garnish combination.

6. The method of claim 5 further comprising storing the condiment and sandwich garnish combination in a chilled area.

7. The method of claim 5 further comprising inverting the combination of bread, condiment, and sandwich garnish.

8. A method of filling an order for a sandwich comprising:
taking an order from a customer; and
in response to the order, heating a preassembled sandwich filling comprising at least one slice of a first foodstuff and a quantity of a second foodstuff from 40° F. or less to 150° F. or more within 20 seconds.

9. The method of claim 8 wherein the preassembled sandwich filling comprises meat, cheese, and a separator.

10. The method of claim 9 wherein the separator is sufficiently larger than the combined area of the meat and cheese that the separator facilitates the separation of preassembled sandwich fillings from each other.

11. The method of claim 9 further comprising removing the separator from the filling after the filling has been heated.

12. The method of claim 9 wherein the sandwich filling comprises a plurality of slices of meat and a quantity of garnish.

13. The method of claim 9 further comprising heating a bread component in response to the order.

14. The method of claim 9 further comprising placing sandwich garnish on a sandwich assembly tool having two cavities.

15. The method of claim 14 further comprising combining a condiment with a sandwich garnish and placing a bread component onto the condiment and sandwich garnish combination.

16. The method of claim 15 further comprising inverting the combination of bread component, condiment, and sandwich garnish.

17. The method of claim 16 further comprising assembling the sandwich using the heated sandwich filling and the combination of bread component, condiment, and sandwich garnish.

18. A method of filling an order for a sandwich comprising:
placing a bread component onto a pre-heated, preassembled sandwich filling comprising a plurality of foodstuffs in response to the order; and
inverting the bread component and filling combination.

19. The method of claim 18 further comprising pre-assembling a sandwich filling in advance of a busy sandwich order period.

20. The method of claim 19 further comprising placing the preassembled sandwich filling in a heated storage area to pre-heat the filling.

21. The method of claim 20 further comprising applying a condiment onto the bread component and filling combination.

22. The method of claim 20 further comprising placing a second bread component onto the inverted bread component and filling combination.

23. The method of claim 18 further comprising heating a bread component in response to the order.

24. The method of claim 18 further comprising pre-assembling garnishes for the sandwich during a slow order period thereby making the preassembled sandwich filling.

25. The method of claim 24 further comprising storing the preassembled garnish in a heated or chilled storage area.

26. The method of claim 25 further comprising placing a second bread component onto the preassembled garnish.

27. The method of claim 26 further comprising inverting the combination of the second bread component and the preassembled garnish.
